(19) United States
(12) Patent Application Publication
(10) Pub. No.: US 2010/0043178 A1
(43) Pub. Date: Feb. 25, 2010

(54) Resilient Axis Damper

(76) Inventors: Robert Reisel, Morton Grove (IL); Darren James Zellak, Morton Grove (IL)

Correspondence Address: FAIER & FAIER P.C., 566 W. ADAMS ST., SUITE 600, CHICAGO, IL, 60661, US

(21) Appl. No.: 12/063,568

(22) PCT Filed: Aug. 7, 2006
(86) PCT No.: PCT/US06/30683

§ 371 Date: Oct. 19, 2009

Related U.S. Application Data
(60) Provisional application No. 60/707,482, filed on Aug. 11, 2005.

(51) Int. Cl. E05F 5/08

(52) U.S. Cl. 16/86 R

(57) ABSTRACT

A resilient axis damper for providing torque and return characteristics for closing and opening action, respectively, of a cover against a frame which has a skeletal member which is secured to the cover and the frame, and a resilient sleeve secured on the skeletal member in a position to absorb torsion forces as the cover is moved in one direction toward the frame and to release torsion forces as the cover is moved in a second direction opposed to the first direction away from the frame.

### BACKGROUND AND SUMMARY OF THE INVENTION

This invention relates to axis dampers for dampening the closure of doors and similar devices which are closed into a frame or cabinet, and is more particularly related to such an axis damper which has a resilient sleeve arranged over a plastic axis damper skeletal member, and which simplifies the structure of the device and yet provided suitable controlled dampening of the closing action of the device. Such a plastic and resilient axis damper device may be co-molded and fabricated in one piece.

Conventional axis dampers are frequently fairly complex devices, usually requiring internal springs and cylinders or discs that move through silicone grease or similar materials or structure to accomplish consistent closing and softening and spring-like opening action to accomplish the desired result.

In the present invention, there are no internal springs or cylinders and there is no structure requiring discs or other elements to move though a dampening agent, and the desired dampening is provided by a resilient sleeve over the dampening device in such a way that torque forces absorb the closing action to suitably move the door or other component home against its frame or cabinet and provide ease of re-opening. Such a simple system is particularly suitable to slow the opening and closing speed of such devices as automobile ashtrays, front panels of television sets, covers for laptop computers and like applications.

By providing a resilient sleeve on an axis damper, suitable dampening and spring action is achieved using molded rubber and plastic, and the rubber or similar resilient cylinder on the device provides torque and return characteristics for closing and opening action at a substantially lower cost than existing axis dampers. The resilient axis damper disclosed in this application can be co-molded in one operation and requires only means for mounting it in place, but no other substantial installation or operational elements.

The resilient axis damper embodying the present invention consists of a plastic skeletal member, which includes structure for mounting the axis damper on a door, panel or cover to be closed or on a frame against which the door, panel or cover is to be closed. The skeletal member includes an axle device for mounting on the door, panel, cover or frame. This axle device has means for receiving a resilient sleeve secured thereover, and this resilient sleeve can be co-molded with the plastic skeletal member.

### OBJECTS AND ADVANTAGES OF THE INVENTION

It is the object of the invention to provide a resilient axis damper of the character described.

Another object is to provide an axis damper having a resilient sleeve which absorbs torque and is spring-like for use to dampen the closing or opening of a door, panel or cover against a frame.

Another object is to provide a resilient member for a axis damper which can be co-molded with the axis damper.

Another object is to provide an axis damper which does not require internal springs, cylinders, discs or similar structure to accomplish consistent closing and softening action to open or close a door, panel or cover.

Another object is to provide an axis damper which can be secured on a frame or door without special members to enhance its dampening action.

Another object is to provide an axis damper which can be fabricated in one piece.

Another object is to provide an axis damper which is simple and efficient to manufacture and use and which can accomplish suitable dampening efficiently and at low cost.

These and other objects and advantages will become more apparent as this description proceeds, taken in conjunction with the accompany drawings and description.

### BRIEF DESCRIPTION OF THE DRAWINGS

In the drawings:

FIG. 1 is a perspective view of a container having an axis damper secured on it hinge and cover.

FIG. 2 is a perspective view of the formed skeleton for an axis damper embodying the present invention.

FIG. 3 is a perspective view of a complete axis damper having a resilient sleeve arranged over the skeleton as seen from its right side, as shown in FIG. 2.

FIG. 4 is a perspective view similar to FIG. 3 except shown from its left side.

FIG. 5 is an elevational view of the axis damper embodying the present invention.

FIG. 6 is an elevational view of the axis damper shown in FIG. 5, viewing the device from its top side.

FIG. 7 is a side elevational view of the axis damper shown in FIG. 5.

### DETAILED DESCRIPTION OF A PREFERRED EMBODIMENT

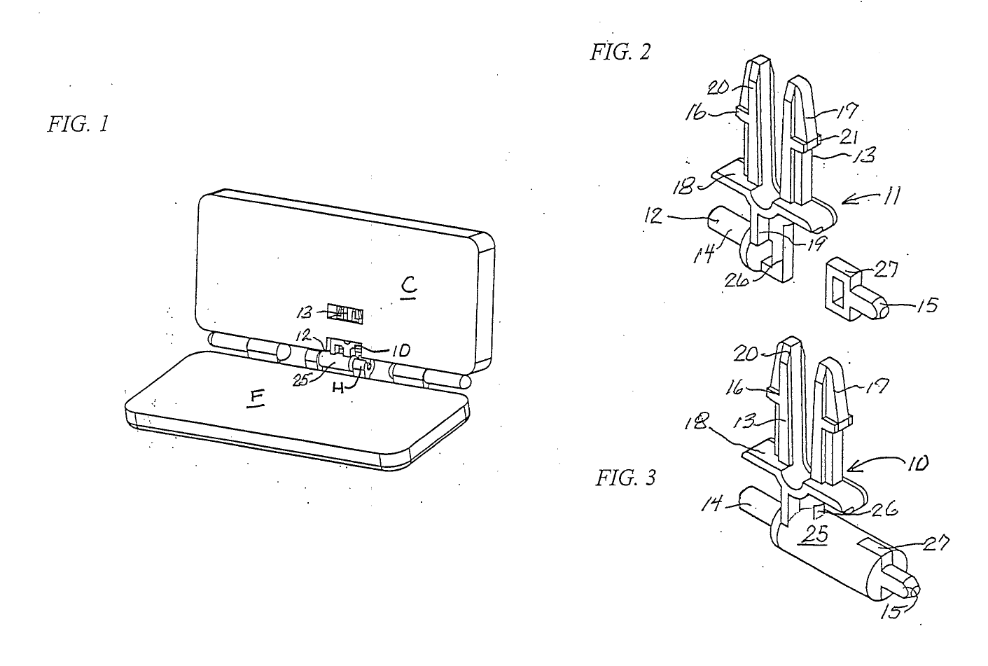

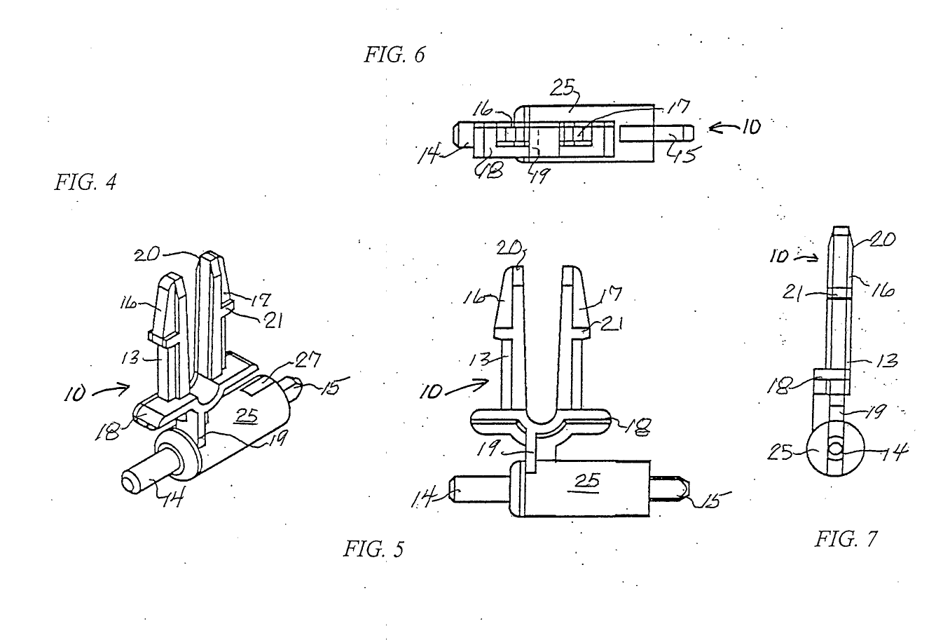

With reference to the accompanying drawing, and particularly to FIG. 1, an axis damper device 10 may be secured in a container have a cover C which may be closed against a body or frame F. One portion of this device may be restrained in a hinge guide H connected to the frame F and its other end can be secured in the container cover C or the like, so that the cover may be swung away from the frame in a dampened fashion, so that it will not be opened too fast or too slow, with only moderating force.

The axis damper device 10 embodying the present invention has a skeleton 11, as shown in FIG. 3. This skeleton 11 consists of a hinge member 12 and a damper restraining member 13. The hinge member 12 may consist of two pins 14 and 15, which are disposed at opposite ends of the skeleton 11, and are adapted to be connected into the hinge guide H for axial movement transverse to the opening and closing of the structure to which the axis damper member is attached.

The damper restraining member 13 on the skeleton 11 may comprise a pair of fork tines 16 and 17 remote and extending from the hinge member 12. These tines 16 are connected together at a base 18 extending from a shaft 19 preferably secured to the hinge member 12, and the remote ends of the tines 16 may form barbs 20 having locking tabs 21 for snap-in connection to structure in the cover C.

Secured to the hinge member 12 of the device 10 is a resilient sleeve 25, which is secured to the hinge member by means of an upstanding brace 26 connected to the shaft 19 and a to a sleeve securing member 27, so that the area of the sleeve between the brace and securing member can absorb torque when the axis damper device is connected to the cover C and body F as the cover is moved toward the frame and release torsion forces as the cover is moved away from the frame. This resilient sleeve 25 may be co-molded with the skeleton member in a single molding operation.

The resilient sleeve maybe made from rubber or other flexible torque absorbing or elastomer material. Skeleton and sleeve arrangements other than as shown and described may be made to similarly lock into a suitable cover and frame so long as these parts are suitable for holding the hinge member 12 and damper restraining member 13 in a position to absorb and release torsion forces while the cover C is moved into closed or open position against the body or fame F.

While a preferred embodiment of the invention has been shown and described in considerable detail, it should be understood that many changes and modifications may be made in the device without departing from the spirit or scope of the invention Accordingly, it should be understood that the invention should not be limited to the exact structure disclosed.

1. A resilient axis damper for providing torque and return characteristics for closing and opening action of cover means against a frame element, said axis damper comprising:
(1) a skeletal member adapted to be secured to said cover means and said frame element, and
(2) a resilient sleeve secured on said skeletal member in a position to absorb torsion forces as said cover means is moved toward said frame element and to release torsion forces as said cover means is moved away from said frame element.

2. The resilient axis damper recited in claim 1, wherein said skeletal member is rigid.

3. The resilient axis damper recited in claim 2, wherein said skeletal member is molded from plastic material.

4. The resilient axis damper recited in claim 1, wherein said sleeve is formed from elastomer material.

5. The resilient axis damper recited in claim 1, wherein said skeletal member and said resilient sleeve are formed in one piece.

6. The resilient axis damper recited in claim 5, wherein said skeletal member and said resilient sleeve are co-molded.

7. The resilient axis damper recited in claim 1, wherein said skeletal member has mounting means for securing said skeletal member to said cover means.

8. The resilient axis damper recited in claim 7, wherein said mounting means comprises a fork-like structure extending angularly from said skeletal member.

9. The resilient axis damper recited in claim 8, wherein said fork-like structure has barbs for securing it in said cover means.

10. The resilient axis damper recited in claim 7, wherein said resilient sleeve is arranged on said skeletal member angularly disposed from said mounting means

11. The resilient axis damper recited in claim 1, wherein said skeletal member has a hinge member connected said cover means and said fame element.

12. The resilient axis damper recited in claim 11, wherein pins are disposed at opposite ends of said hinge member transverse to the opening and closing of said cover means toward and away from said frame element.

13. The resilient axis damper recited in claim 12, wherein said resilient sleeve is secured to said hinge member.

14. The resilient axis damaged recited in claim 13, wherein brace means secures said resilient sleeve on said hinge member.

15. In a resilient axis damper, the improvement comprising a skeletal member for movably securing said axis damper to a surface and a resilient sleeve connected to said skeletal member, said resilient sleeve being adapted to absorb torsion forces when said surface moves in one direction relative to said skeletal member and to release such torsion forces when said surface moves in a second direction opposed to said one direction.

16. In a method for dampening movement of a cover against a frame and for easing said cover away from said frame, said method comprising the steps of (a) securing said frame and cover together by a skeletal member having a hinge, and (b) attaching a resilient member to said hinge in a position to absorb torque when said cover is moved relative to said frame in one direction and release torsion forces absorbed by said resilient member when said cover is moved relative to said frame in an second direction opposed to said one direction.
